(19) United States
(12) Patent Application Publication
(10) Pub. No.: US 2019/0316014 A1
(43) Pub. Date: Oct. 17, 2019

(54) REACTIVE POLYURETHANE HOT-MELT ADHESIVES

(71) Applicant: BASF SE, Ludwigshafen am Rhein (DE)

(72) Inventors: Julio ALBUERNE, Lemfoerde (DE); Rolf ILLGUTH, Lemfoerde (DE); Raphael DABBOUS, Basel (CH); Elmar POESELT, Lemfoerde (DE)

(73) Assignee: BASF SE, Ludwigshafen am Rhein (DE)

(21) Appl. No.: 16/348,259

(22) PCT Filed: Dec. 1, 2017
(86) PCT No.: PCT/EP2017/081173

§ 371 Date: May 8, 2019

(30) Foreign Application Priority Data
Dec. 2, 2016 (EP) 16201928.5

(51) Int. Cl. C09J 175/08; C08G 18/76; C08G 18/48; C08G 18/42; C08G 18/62; C08G 18/40; C08K 5/00; C09J 11/06; C09J 5/06; C09K 3/10; C09D 175/08; B33Y 70/00

(52) U.S. Cl. CPC C09J 175/08; C09K 2200/065; C08G 18/4825; C08G 18/4238; C08G 18/6225; C08G 18/4063; C08K 5/0041; C08K 5/0083; C09J 11/06; C09J 5/06; C09K 3/1021; C09D 175/08; B33Y 70/00; C08G 2170/20; C09J 2475/00; C08G 18/7664

(57) ABSTRACT

The present invention relates to a composition comprising at least one crosslinkable thermoplastic polyurethane (P) and at least one compound (N) having a conjugated, nitrogen-containing aromatic structure as nucleating agent, wherein the compound (N) is a solid and is present in the composition in an amount within a range from 0.01% to 0.5% by weight, based on the thermoplastic polyurethane. The present invention further relates to a process for producing such compositions and to the use of the compositions of the invention as sealant, coating or adhesive

The present invention relates to a composition comprising at least one crosslinkable thermoplastic polyurethane (P) and at least one compound (N) having a conjugated, nitrogen-containing aromatic structure as nucleating agent, wherein the compound (N) is a solid and is present in the composition in an amount within a range from 0.01% to 0.5% by weight, based on the thermoplastic polyurethane. The present invention further relates to a process for producing such compositions and to the use of the compositions of the invention as sealant, coating or adhesive.

The prior art discloses various thermoplastic polyurethanes. The properties of the thermoplastic polyurethanes can be varied within wide ranges by the use of different feedstocks or else by the use of additives. For example, EP 0 199 021 A2 discloses that the use of nucleating agents can affect the crystallization characteristics of polyurethanes.

Crosslinkable thermoplastic polyurethanes for adhesive applications are also referred to as reactive polyurethane hotmelts. Reactive polyurethane hotmelts are a product group which is experiencing significant growth among the applications of polyurethanes in the adhesives sector. They are constructed using preferably linear polyester polyols and/or polyether polyols in combination with an excess of polyisocyanates, preferably diisocyanates.

An essential factor for the good profile of properties of the reactive polyurethane hotmelts is their ability to build up cohesion strengths (initial strengths) very rapidly in the course of cooling, which permits handling of the joined parts immediately after the joining. For many applications, a particularly rapid buildup of strength is necessary in order, for example, to enable rapid further processing in the case of short cycle times or to be able to absorb resilience forces in the substrates without occurrence of detachment phenomena.

The actual curing of the reactive PUR hotmelts, i.e. crosslinking reaction of the components with one another, typically proceeds within hours to days through reaction of the free isocyanate groups with water from the environment or the mutually adhesive-bonded substrates to give polyurea. Thereafter, the PUR hotmelts are only of limited fusibility or solubility in solvents. For that reason, the cured adhesives have good thermal stability and stability to chemicals such as plasticizers, solvents, oils or fuels.

Reactive hotmelts based on semicrystalline polyesters as described, for example, in DE 38 27 224 A1 are notable for a very short open time and an associated rapid buildup of initial strength. This is achieved, for example, through the use of esters based on dodecanedioic acid, which are known to have very rapid recrystallization kinetics and a high melting point.

It is known from WO2005/066256, for example, that transition temperatures and enthalpies of recrystallization of semicrystalline thermoplastic polymers of high molecular weight, for example polyolefins or polyesters, can be increased by addition of nucleating agents. This can improve, for example, demoldability and hence cycle times in injection molding.

The effect of nucleating agents on the initial strength of solvent-containing thermoplastic polyurethane elastomers of high molecular weight is described, for example, in WO 2008/155018 A1.

For many applications, it is necessary that good initial adhesion is already attained rapidly prior to crosslinking.

It was thus an object of the invention to provide formulations that allow more rapid buildup of initial strength.

Proceeding from the prior art, it was a further object of the present invention to provide compositions comprising crosslinkable thermoplastic polyurethanes or processes for production of such compositions that are available in a simple and inexpensive manner, and the adhesion characteristics of which can be adjusted efficiently.

According to the invention, this object is achieved by a composition comprising at least one crosslinkable thermoplastic polyurethane (P) and at least one compound (N) having a conjugated, nitrogen-containing aromatic structure as nucleating agent, wherein the compound (N) is a solid and is present in the composition in an amount within a range from 0.01% to 0.5% by weight, based on the thermoplastic polyurethane.

In the context of the present invention, suitable crosslinkable thermoplastic polyurethanes (P) are in principle any thermoplastic polyurethanes that can initially cure and/or crystallize within a defined temperature range and preferably have functional groups that allow crosslinking of the cured or crystallized polyurethane. Especially suitable are those thermoplastic polyurethanes that can be crosslinked, for example, via allophanates, biuret groups, silanes, isocyanurate groups or double bonds. In the context of the present invention, the proportion of the free groups and the proportion of crosslinking is variable within wide ranges.

Preferably, in the context of the present invention, the crosslinkable thermoplastic polyurethane (P) used is a thermoplastic polyurethane which, after curing and/or crystallizing, has a concentration of free NCO groups in the range from 0.1% to 10% by weight, preferably in the range from 0.5% to 8% by weight, more preferably in the range from 1% to 5% by weight.

According to the invention, a compound (N) having a conjugated, nitrogen-containing aromatic structure is used as nucleating agent, where the compound (N) is a solid at room temperature. In the context of the present invention, the compound (N) is also referred to as nucleating agent. This nucleating agent is selected, for example, from the group consisting of quinacridones, monoazo compounds, perylenes, diketopyrrolopyrroles, isoindolines and phthalocyanines or derivatives of these compounds.

The present invention therefore further relates to a process for producing a composition as described above, at least comprising the steps of
(i) providing at least one crosslinkable thermoplastic polyurethane (P) or a reaction mixture for preparation of a crosslinkable thermoplastic polyurethane (R-P);
(ii) adding at least one compound (N) that has a conjugated, nitrogen-containing aromatic structure as nucleating agent to the at least one thermoplastic polyurethane (P) or to the reaction mixture for preparation of a crosslinkable thermoplastic polyurethane (R-P), where the compound (N) is a solid;
(iii) mixing the nucleating agent and the thermoplastic polyurethane (P) or the reaction mixture (R-P),
   wherein the amount of the sum total of the nucleating agents used is in the range from 0.01% by weight to 0.5% by weight, based on the thermoplastic polyurethane (P) or the reaction mixture (R-P).

According to the invention, compounds used as compounds (N) have aromatic systems. Suitable examples of such compounds in the context of the present invention are those that are used as organic pigments or else derivatives of these. Some such products form part of the prior art for coloring of coatings or plastics. A detailed list can be found in the reference “Lehrbuch der Lacke und Beschichtungen” [Textbook of Paints and Coatings] by Hans Kittel, volume 5 (5. Pigmente, Füllstoffe und Farbmetrik [Pigments, Fillers and Colorimetry]/volume ed. Jürgen Spille), chapter 5.4, 2003, ISBN 3-7776-1015-1.

The use of a compound (N) having a conjugated, nitrogen-containing aromatic structure, such as quinacridones, monoazo compounds, perylenes, diketopyrrolopyrroles, isoindolines and phthalocyanines or derivatives of these compounds, as color pigment is known in principle from the prior art. It has been found that, surprisingly, solid compounds having a conjugated, nitrogen-containing aromatic structure can be used in very small amounts in the range from 0.01% by weight to 0.5% by weight as strong nucleating agents for crosslinkable thermoplastic polyurethanes.

By the process of the invention, it is also possible to use inexpensive polyesterols as raw materials, for example polyesters obtainable by reaction of adipic acid and butanediol or hexanediol, giving products having good properties. It is thus possible to avoid, for example, polyesterols based on dodecanoic acid.

Especially compounds selected from the group consisting of quinacridones, monoazo compounds, perylenes, diketopyrrolopyrroles, isoindolines and phthalocyanines or derivatives of these compounds, especially of quinacridone derivatives, in very small amounts in the range from 0.01% by weight to 0.5% by weight, act as strong nucleating agents for crosslinkable thermoplastic polyurethanes. Further preferably, the nucleating agent is selected from the group consisting of quinacridones and perylenes or derivatives of these compounds.

In a further embodiment, the present invention also relates to a composition as described above, wherein the nucleating agent is selected from the group consisting of quinacridones, monoazo compounds, perylenes, diketopyrrolopyrroles, isoindolines and phthalocyanines or derivatives of these compounds.

In a further embodiment, the present invention also relates to a composition as described above, wherein the nucleating agent is selected from the group consisting of quinacridones and perylenes or derivatives of these compounds.

According to the invention, the at least one compound (N) can also be used in combination with other nucleating agents, for example in combination with one or more nucleating agents selected from the group consisting of talc, carbon black and shear-thinning additives.

It has been found that, surprisingly, specifically the small amount used of the nucleating agents used, especially of the quinacridone derivatives and perylenes, has a strong nucleating effect. By virtue of the small amount used, there is additionally only a minor degree, if any, of deterioration in the other properties of the crosslinkable thermoplastic polyurethane. This effect occurs even in the case of small amounts, for example amounts in the range from 0.02% by weight to 0.3% by weight, preferably amounts in the range from 0.03% by weight to 0.1% by weight, further preferably amounts in the range from 0.04% by weight to 0.08% by weight.

At the same time, in the context of the present invention, there is preferably no adverse effect on the molecular weight of the thermoplastic polyurethane used.

In a further embodiment, the present invention also relates to a composition as described above, wherein the amount of the sum total of the nucleating agents used is in the range from 0.03% by weight to 0.1% by weight, based on the thermoplastic polyurethane (P).

Examples of compounds suitable in accordance with the invention are the following families with the corresponding Colour Index (C.I.):
monoazo: non-laked yellow 1, 3, 5, 6, 60, 65, 73, 74, 75, 97, 98, 111, 116, orange 1; laked yellow 113, 168, 169, 183, 190, 191;
perylenes red 123, 149, 178, 179, 190, 224 and violet 29;
phthalocyanines blue 15, 15:1, 15:2, 15:3, 15:4, 15:6, 16, 68, and green 7, 36;
quinacridones orange 48, 49, red 122, 192, 202, 206, 207, 209, violet 19, 30, 42;
diketopyrrolopyrroles red 254, 255;
isoindolines/ones yellow 110, 139, 173, 185, orange 61, 66, 69, red 260 and brown 38.

In principle, the compounds used as nucleating agents can also be subjected to a treatment in order, for example, to improve miscibility with the thermoplastic polyurethane.

In a further embodiment, the present invention also relates to a composition as described above, wherein a nucleating agent that has been subjected to a treatment comprising grinding, treatment with a solvent, acids, alkalis, bleaches, crystallization or extraction, and finishing operations to reduce or prevent flocculation or lump formation, finishing operations to control the particle size, or finishing operations to regulate the viscosity is used.

Typically, the nucleating agents are used in solid form in the context of the present invention. Preferably, the at least one nucleating agent has a high specific surface area (unless stated otherwise determined by means of the gas adsorption BET method according to ISO 9277), for example a specific surface area in the range from 10 m²/g to 150 m²/g, preferably specific surface area of greater than 35 m²/g, further preferably of greater than 55 m²/g.

In a further embodiment, the present invention also relates to a composition as described above, wherein the nucleating agent is used in the form of a solid having a specific surface area in the range from 10 m²/g to 150 m²/g.

According to the invention, in one embodiment, at least one quinacridone derivative is used as nucleating agent. Suitable compounds are known per se to the person skilled in the art and are also used in larger volumes as color pigments. Suitable quinacridone derivatives are, for example, substituted or unsubstituted quinacridone derivatives, substituted or unsubstituted dihydroquinacridone derivatives and substituted or unsubstituted quinacridonequinone derivatives.

Preferably, the quinacridone derivative is selected from the group consisting of quinacridone derivatives of the formula (I), dihydroquinacridone derivatives of the formula (II) and quinacridonequinone derivatives of the formula (III):

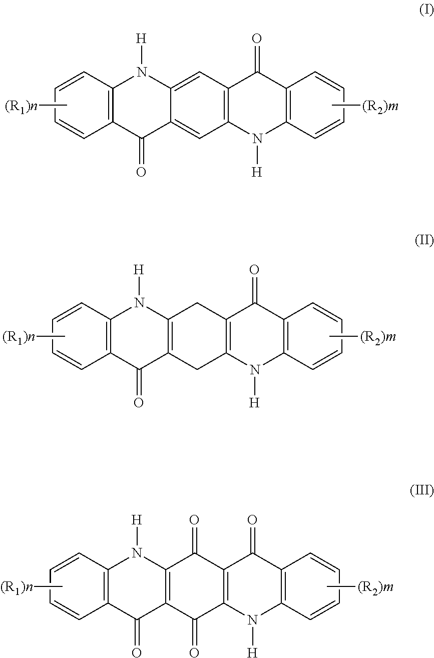

where R₁ and R₂ are independently selected from the group consisting of fluorine, chlorine, bromine, C1 to C6-alkyl or C1-C6-alkoxy, and n and m are independently an integer from 0 to 4. n and m are preferably independently 0 or 1.

According to the invention, it is also possible to use mixtures of two or more quinacridone derivatives.

According to the invention, the quinacridone derivatives used may have different substitutions. Preference is given to using quinacridone derivatives having halogen substituents or alkyl substituents, for example having chlorine or methyl substituents. Suitable compounds are, for example, compounds having the following structures:

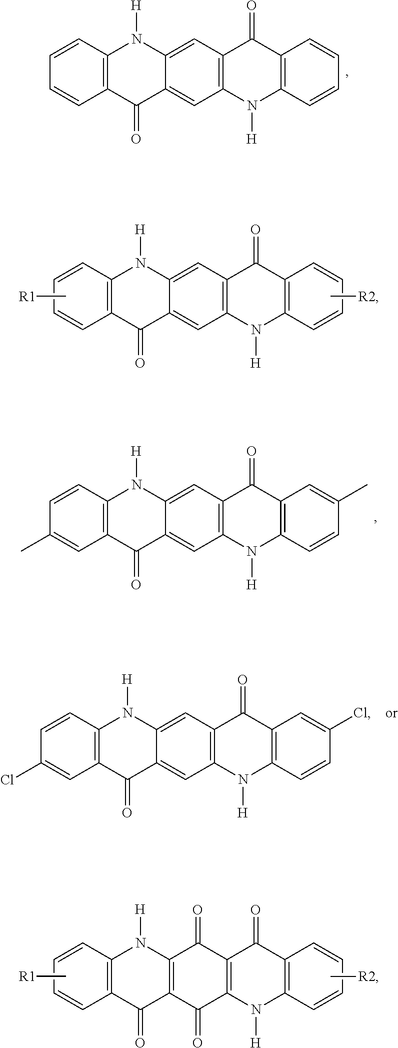

where R1, R2, n and m are as defined above.

According to the invention, in a further embodiment, at least one diketopyrrolopyrrole derivative is used as nucleating agent. Suitable compounds are known per se to the person skilled in the art and are also used in larger volumes as color pigments.

Preferably, the diketopyrrolopyrrole derivative is selected from the group consisting of diketopyrrolopyrrole derivatives of the formula (IV):

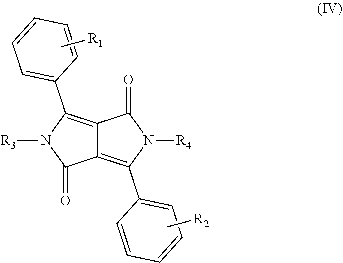

where R1 and R2 are independently selected from the groups consisting of hydrogen, C□-□□-alkyl, C□-C□-alkoxy, phenyl, cyano or halogen and R3 and R4 are also independently selected from the groups consisting of hydrogen, C□-□□-alkyl, C□-□□-alkenyl, C□-C□-alkynyl, C□-C□-alkoxycarbonyl, carbamoyl, C□-□□-alkyl, C□-C□-alkoxycarbonyl, phenyl or phenyl substituted by chlorine, bromine, C□-C□-alkyl, C□-C□-alkoxy, trifluoromethyl or nitro.

According to the invention, it is also possible to use mixtures of two or more diketopyrrolopyrrole derivatives.

According to the invention, the diketopyrrolopyrrole derivatives used may have different substitutions. Preference is given to using diketopyrrolopyrrole derivatives having halogen substituents or aromatic substituents, for example having chlorine or phenyl substituents. Suitable compounds are, for example, compounds having the following structures:

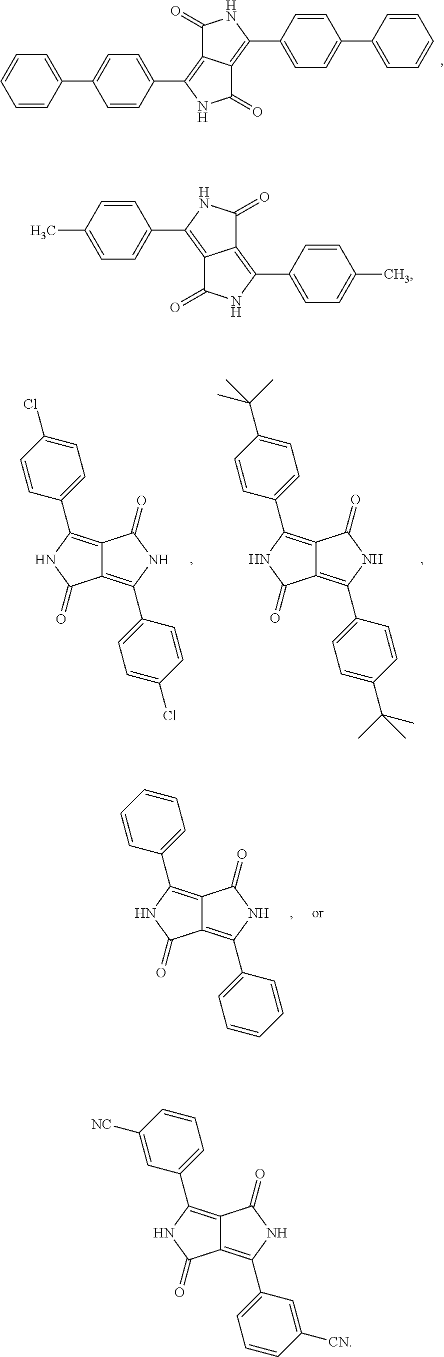 [SMILES: O=C1NC(c2ccc(-c3ccccc3)cc2)=C2C(=O)NC(c3ccc(-c4ccccc4)cc3)=C12 ; Cc1ccc(C2=C3C(=O)NC(c4ccc(C)cc4)=C3C(=O)N2)cc1 ; O=C1NC(c2ccc(Cl)cc2)=C2C(=O)NC(c3ccc(Cl)cc3)=C12 ; CC(C)(C)c1ccc(C2=C3C(=O)NC(c4ccc(C(C)(C)C)cc4)=C3C(=O)N2)cc1 ; O=C1NC(c2ccccc2)=C2C(=O)NC(c3ccccc3)=C12 ; N#Cc1cccc(C2=C3C(=O)NC(c4cccc(C#N)c4)=C3C(=O)N2)c1]

According to the invention, it is also possible to use phthalocyanines as nucleating agents. Preferably, the phthalocyanine derivative is selected from the group consisting of aluminum phthalocyanine, nickel phthalocyanine, cobalt phthalocyanine, iron phthalocyanine, zinc phthalocyanine, copper phthalocyanine, polychloro copper phthalocyanine, hexadecachlorophthalocyanine, hexadecabromophthalocyanine and manganese phthalocyanine and derivatives thereof.

For example, in the context of the present invention, it is possible to use the following phthalocyanines or derivatives thereof:
aluminum phthalocyanine, for example with CAS No.: 14154-42-8,
nickel phthalocyanine, for example with CAS No.: 14055-02-8,
cobalt phthalocyanine, for example with CAS No.: 3317-67-7,
iron phthalocyanine, for example with CAS No.: 132-16-1,
zinc phthalocyanine, for example with CAS No.: 14320-04-08,
copper phthalocyanine, for example with CAS No.: 147-14-8,
polychloro copper phthalocyanine, for example with CAS No.: 1328-53-6,
hexadecachlorophthalocyanine, for example with CAS No.: 28888-81-5,
hexadecabromophthalocyanine, for example with CAS No.: 28746-04-5,
manganese phthalocyanine, for example with CAS No.: 14325-24-7.

In the context of the present invention, preference is given to copper phthalocyanine having the following structure or derivatives thereof:

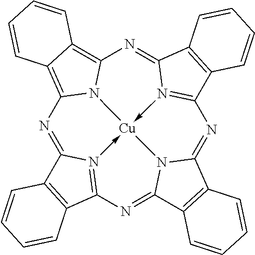

Crosslinkable thermoplastic polyurethanes (P) used in accordance with the invention may be any standard crosslinkable thermoplastic polyurethanes. In the context of the present invention, it is also possible that mixtures of different crosslinkable thermoplastic polyurethanes are used. In the context of the present invention, a crosslinkable thermoplastic polyurethane is understood to mean a polyurethane which is thermoplastic and has free functional groups suitable for crosslinking. Once crosslinking has been effected, the polyurethane typically no longer has thermoplastic properties. Depending on the nature of the crosslinking, however, this may also be reversible in the context of the present invention. For example, the crosslinking may be thermally cleaved in some cases. After cleavage of the crosslinking, the polyurethane may again have thermoplastic properties.

Especially suitable are those thermoplastic polyurethanes that can be crosslinked via allophanates, silanes, biuret groups, isocyanurate groups or double bonds.

Preferably, crosslinking in the context of the present invention is effected at room temperature. The crosslinking can also be effected at an air humidity in the range from 50% to 100%. According to the invention, it is also possible that the crosslinking is initiated and/or accelerated by addition of suitable catalysts or by radiation.

Thermoplastic polyurethanes are typically prepared by means of reaction of at least one polyol composition, at least one chain extender, and at least one polyisocyanate composition. Accordingly, a reaction mixture for preparation of a crosslinkable thermoplastic polyurethane (R-P) typically comprises at least one polyol composition, optionally a chain extender and at least one polyisocyanate composition. In the context of the present invention, it is possible that the nucleating agent is added, for example, to the polyol composition. It is likewise possible that the nucleating agent is added to the reaction mixture after addition of all components, i.e. more particularly after the mixing of the polyol composition and the isocyanate composition.

Suitable polyol compositions for preparation of thermoplastic polyurethanes are known in principle to those skilled in the art. Suitable polyols are selected, for example, from the group consisting of polyetherols, polyesterols, polycarbonate alcohols and hybrid polyols, preferably selected from the group consisting of polyetherols and polyesterols. Particular preference is given to polyester polyols, for example those based on adipic acid and a diol. Suitable diols are especially butane-1,4-diol, hexane-1,6-diol or mixtures of these compounds.

Polyols of this kind are known in principle to those skilled in the art and described for example in “Kunststoffhandbuch [Plastics Handbook], volume 7, Polyurethane [Polyurethanes]”, Carl Hanser Verlag, 3rd edition 1993, chapter 3.1. Particular preference is given to using polyesterols or polyetherols as polyols. It is likewise possible to use polycarbonates.

Copolymers may also be used in the context of the present invention. The number-average molecular weight of polyols used in accordance with the invention is in the range from 0.5×10³ g/mol to 8×10³ g/mol, preferably in the range from 0.6×10³ g/mol to 5×10³ g/mol, especially in the range from 0.8×10³ g/mol to 3×10³ g/mol. Unless stated otherwise, the figures relate to molecular weights which by means of GPC using PMMA standards having molecular weights between 0.2 and 47 kg/mol.

Preferred polyetherols are in accordance with the invention polyethylene glycols, polypropylene glycols and polytetrahydrofurans.

Polyesterols are prepared, for example, from alkanedicarboxylic acids and polyhydric alcohols, polythioether polyols, polyesteram ides, hydroxyl-containing polyacetals and/or hydroxyl-containing aliphatic polycarbonates, preferably in the presence of an esterification catalyst. Further possible polyols are specified, for example, in “Kunststoffhandbuch, Band 7, Polyurethane” [Plastics Handbook, volume 7, Polyurethanes], Carl Hanser Verlag, 3rd edition 1993, chapter 3.1.

The polyesterols that are employed with preference may be prepared, for example, from dicarboxylic acids having 2 to 12 carbon atoms, and polyhydric alcohols. Examples of useful dicarboxylic acids include: aliphatic dicarboxylic acids, such as succinic acid, glutaric acid, adipic acid, suberic acid, azelaic acid, sebacic acid and dodecane-1,12-dioic acid, and aromatic dicarboxylic acids, such as phthalic acid, isophthalic acid and terephthalic acid. The dicarboxylic acids may be used individually or in the form of mixtures, for example in the form of a mixture of succinic, glutaric, and adipic acid. For preparation of the polyesterols, it may be advantageous, rather than the dicarboxylic acids, to use the corresponding dicarboxylic acid derivatives, such as dicarboxylic esters having 1 to 4 carbon atoms in the alcohol radical, dicarboxylic anhydrides or dicarbonyl chlorides. Examples of polyhydric alcohols include glycols having 2 to 10 and preferably 2 to 6 carbon atoms, such as ethylene glycol, diethylene glycol, butane-1,4-diol, pentane-1,5-diol, hexane-1,6-diol, decane-1,10-diol, 2,2-dimethylpropane-1,3-diol, propane-1,3-diol and dipropylene glycol, triols having 3 to 6 carbon atoms, for example glycerol and trimethylolpropane, and pentaerythritol as a higher polyhydric alcohol. Depending on the desired properties, the polyhydric alcohols may be used alone or optionally in mixtures with one another.

According to the invention, preferred polyesterols are those after the reaction of adipic acid with butane-1,4-diol, adipic acid with hexane-1,6-diol, dodecane-1,12-dioic acid with butane-1,4-diol, and dodecane-1,12-dioic acid with hexane-1,6-diol.

Preferably, the polyols used have an average OH functionality between 1.8 and 2.3, preferably between 1.9 and 2.2, especially 2. Preferably, the polyols used in accordance with the invention have solely primary hydroxyl groups.

According to the invention, the polyol may be used in pure form or in the form of a composition comprising the polyol and at least one solvent. Suitable solvents are known per se to the person skilled in the art.

For preparation of the thermoplastic polyurethanes, it is also possible to use a chain extender, but it is also possible to use mixtures of different chain extenders.

Chain extenders used may typically be compounds having hydroxyl or amino groups, especially having 2 hydroxyl or amino groups. According to the invention, however, it is also possible that mixtures of different compounds are used as chain extenders. According to the invention, the average functionality of the mixture is preferably 2.

Preference is given in accordance with the invention to using compounds having hydroxyl groups as chain extenders, especially diols. It is preferably possible to use aliphatic, araliphatic, aromatic and/or cycloaliphatic diols having a molecular weight of 50 g/mol to 220 g/mol. Preference is given to alkanediols having 2 to 10 carbon atoms in the alkylene radical, especially di-, tri-, tetra-, penta-, hexa-, hepta-, octa-, nona- and/or decaalkylene glycols. For the present invention, particular preference is given to 1,2-ethylene glycol, propane-1,3-diol, butane-1,4-diol, hexane-1,6-diol. It is also possible to use aromatic compounds such as hydroxyquinone bis(2-hydroxyethyl) ether.

According to the invention, it is also possible to use compounds having amino groups, for example diamines. It is likewise possible to use mixtures of diols and diamines.

The chain extender is preferably a diol having a molecular weight Mw<220 g/mol. According to the invention, it is possible that only one diol having a molecular weight Mw<220 g/mol is used for preparation of the thermoplastic polyurethane.

In a further embodiment, the chain extender is selected from the group consisting of butane-1,2-diol, propane-1,3-diol, butane-1,4-diol, hexane-1,6-diol and hydroxyquinone bis(2-hydroxyethyl) ether.

In addition, at least one polyisocyanate is used for preparation of the thermoplastic polyurethane. According to the invention, it is also possible to use mixtures of two or more polyisocyanates.

Preferred polyisocyanates in the context of the present invention are diisocyanates, especially aliphatic or aromatic diisocyanates, further preferably aromatic diisocyanates.

In a further embodiment, the present invention accordingly relates to a process as described above, wherein the polyisocyanate is an aromatic diisocyanate.

In addition, in the context of the present invention, isocyanate components used may be prereacted prepolymers in which some of the OH components have been reacted with an isocyanate in a preceding reaction step. These prepolymers are reacted with the remaining OH components in a further step, the actual polymer reaction, and then form the thermoplastic polyurethane. The use of prepolymers makes it possible also to use OH components having secondary alcohol groups.

Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylenedicyclohexyl 4,4′-, 2,4′- and/or 2,2′-diisocyanate (H12MDI).

Preferred aliphatic polyisocyanates are hexamethylene 1,6-diisocyanate (HDI), 1-isocyanato-3,3,5-trimethyl-5-isocyanatomethylcyclohexane and methylene dicyclohexyl 4,4′-, 2,4′- and/or 2,2′-diisocyanate (H12MD1); especially preferred are methylene dicyclohexyl 4,4′-, 2,4′- and/or 2,2′-diisocyanate (H12MDI) and 1-isocyanato-3,3,5-trimethyl-5-isocyanatomethylcyclohexane or mixtures thereof.

In a further embodiment, the present invention accordingly relates to a process as described above, wherein the polyisocyanate is selected from the group consisting of methylene dicyclohexyl 4,4′-, 2,4′- and/or 2,2′-diisocyanate (H12MDI), hexamethylene diisocyanate (HDI) and 1-isocyanato-3,3,5-trimethyl-5-isocyanatomethylcyclohexane (IPDI) or mixtures thereof.

Suitable aromatic diisocyanates are especially diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethyl-4,4′-diisocyanatodiphenyl (TODD, p-phenylene diisocyanate (PDI), diphenylethane 4,4′-diisocyanate (EDI), diphenylmethane diisocyanate, dimethyl diphenyl 3,3′-diisocyanate, diphenylethane 1,2-diisocyanate and/or phenylene diisocyanate.

Preferred aromatic polyisocyanates are especially diphenylmethane 2,2′-, 2,4′- and/or 4,4′-diisocyanate (MDI).

According to the invention, the polyisocyanate may be used in pure form or in the form of a composition comprising the polyisocyanate and at least one solvent. Suitable solvents are known to those skilled in the art. Suitable examples are nonreactive solvents such as ethyl acetate, methyl ethyl ketone and hydrocarbons.

According to the invention, it is possible to add further feedstocks in the reaction, for example catalysts or auxiliaries and additives.

Suitable auxiliaries and additives are known per se to those skilled in the art. Examples include surface-active substances, flame retardants, nucleating agents, oxidation stabilizers, antioxidants, lubricants, dyes and pigments, stabilizers, for example against hydrolysis, light, heat or discoloration, inorganic and/or organic fillers, fibers, reinforcers and plasticizers. Suitable auxiliaries and additives may be found, for example, in Kunststoffhandbuch [Plastics Handbook], volume VII, published by Vieweg and Hochtlen, Carl Hanser Verlag, Munich 1966 (p. 103-113).

Suitable catalysts are likewise known in principle from the prior art.

According to the invention, it is especially possible that the nucleating agent is used in combination with further additives, for example waxes.

In a further embodiment, the present invention accordingly also relates to a process for producing a composition (I) at least comprising a crosslinkable thermoplastic polyurethane (P) as described above, wherein the nucleating agent is used in combination with a further additive.

Suitable additives, in addition to those mentioned above, are disclosed, for example, in DE 19735974 A1, especially at page 9 line 62 to page 12 line 4. Additives used in the context of the present invention are selected, for example, from an antioxidant, a light stabilizer, a metal deactivator, a stabilizer, a filler, a flame retardant, a plasticizer, a wax, a further nucleating agent, a processing agent, a dye, a pigment or a combination of at least two additives.

According to the invention, further nucleating agents used may be any suitable compounds that trigger or promote the formation of a crystalline phase from the melt or solution and/or crystal growth on existing crystal surfaces. Suitable further nucleating agents that can be used together with the nucleating agent (N) are selected, for example, from the group consisting of inorganic salts and oxides such as talc, calcite or attapulgite; colloidal silver or gold; hydrazones, sodium or aluminum benzoates; aluminum, sodium and calcium salts of aromatic or aliphatic/cycloaliphatic acids, for example calcium terephthalate; derivatives of phosphoric acids or organophosphates; pigments; sorbitols; pine resins; or polymeric nucleating agents, for example polycyclopentene or polyvinylcyclohexane and mixtures of these.

In a further aspect, the present invention also relates to a process for producing a composition as described above, at least comprising the steps of
(i) providing at least one crosslinkable thermoplastic polyurethane (P) or a reaction mixture for preparation of a crosslinkable thermoplastic polyurethane (R-P);
(ii) adding at least one compound (N) that has a conjugated, nitrogen-containing aromatic structure as nucleating agent to the at least one thermoplastic polyurethane (P) or to the reaction mixture for preparation of a crosslinkable thermoplastic polyurethane (R-P), where the compound (N) is a solid;
(iii) mixing the nucleating agent and the thermoplastic polyurethane (P) or the reaction mixture (R-P),
   wherein the amount of the sum total of the nucleating agents used is in the range from 0.01% by weight to 0.5% by weight, based on the thermoplastic polyurethane (P) or the reaction mixture (R-P).

The present invention thus relates to a process for producing a composition comprising at least one crosslinkable thermoplastic polyurethane (P) and at least one compound (N) having a conjugated, nitrogen-containing aromatic structure as nucleating agent, wherein the compound (N) is a solid and is present in the composition in an amount within a range from 0.01% to 0.5% by weight, based on the thermoplastic polyurethane, at least comprising the steps of
(i) providing at least one crosslinkable thermoplastic polyurethane (P) or a reaction mixture for preparation of a crosslinkable thermoplastic polyurethane (R-P);
(ii) adding at least one compound (N) that has a conjugated, nitrogen-containing aromatic structure as nucleating agent to the at least one thermoplastic polyurethane (P) or to the reaction mixture for preparation of a crosslinkable thermoplastic polyurethane (R-P), where the compound (N) is a solid;
(iii) mixing the nucleating agent and the thermoplastic polyurethane (P) or the reaction mixture (R-P),
   wherein the amount of the sum total of the nucleating agents used is in the range from 0.01% by weight to 0.5% by weight, based on the thermoplastic polyurethane (P) or the reaction mixture (R-P).

With regard to the preferred embodiments, reference is made to the details above.

In a further embodiment, the present invention also relates to a process as described above, wherein the nucleating agent is selected from the group consisting of quinacridones, monoazo compounds, perylenes, diketopyrrolopyrroles, isoindolines and phthalocyanines or derivatives of these compounds.

The present invention also further relates to a process as described above, wherein the nucleating agent is selected from the group consisting of quinacridones and perylenes or derivatives of these compounds.

In a further embodiment, the present invention thus also relates to a process as described above, wherein the amount of the sum total of the nucleating agents used is in the range from 0.03% by weight to 0.1% by weight, based on the thermoplastic polyurethane (P).

The process of the invention comprises steps (i) to (iii). First of all, in step (i), a crosslinkable thermoplastic polyurethane (P) or a reaction mixture for production of a crosslinkable thermoplastic polyurethane (R-P) is provided. In step (ii), a nucleating agent as defined above is then added to the at least one thermoplastic polyurethane (P) or to the reaction mixture for production of a crosslinkable thermoplastic polyurethane (R-P), wherein the amount of the sum total of the nucleating agents used is in the range from 0.01% by weight to 0.5% by weight, based on the thermoplastic polyurethane (P) or the reaction mixture (R-P). In step (iii), the nucleating agent and the thermoplastic polyurethane (P) or the reaction mixture (R-P) are mixed to obtain a composition (I).

The addition or the mixing is preferably effected in apparatuses that are used customarily for mixing of substances, for example in drum mixers, in mills, in screw or disk extruders, roll mills or kneaders. The at least one crosslinkable thermoplastic polyurethane (P) or the reaction mixture (R-P) and the at least one nucleating agent are mixed with one another in the mixing apparatus typically at an elevated temperature, especially within the melting range of the crosslinkable thermoplastic polyurethane (P) used. The mixing operation is generally effected at pressures of 1 to 200 bar with mean residence times of 0.5 to 60 minutes. If the nucleating agent is added to the reaction mixture (R-P), this is typically effected in accordance with the invention under the conditions under which the components of the reaction mixture (R-P) are mixed. In the context of the present invention, the nucleating agent may be added, for example, to the polyol or to the isocyanate.

The process of the invention may include further steps, especially thermal treatments of the composition (I).

In a further embodiment, the present invention accordingly also relates to a process for producing a composition (I) at least comprising a crosslinkable thermoplastic polyurethane (P) as described above, wherein the process comprises steps (iv) and (v):
(iv) heating the composition (I) to a temperature in the region of the melting range of the thermoplastic polyurethane (P) with at least partial melting of the thermoplastic polyurethane (P);
(v) cooling the composition.

In the context of the present invention, the cooling in step (v) is typically effected at a cooling rate in the region of cooling rates that are used in DSC measurements, for example at a cooling rate of 20° C./min.

In the context of such an embodiment, the composition (I) obtained is heated in step (iv) to a temperature in the region of the melting range of the thermoplastic polyurethane (P) with at least partial melting of the thermoplastic polyurethane (P). Finally, in step (v), the composition (I) is cooled.

According to the invention, the heating can be effected in any suitable manner known to the person skilled in the art. Preferably, the heating is effected by electrical heating, heating via heated oil or water, mechanical friction, shear, induction fields, hot air, IR radiation or high-energy radiation (laser).

The process of the invention may comprise further steps.

Preferably, the amount of the sum total of the compound (N) used is in the range from 0.02% by weight to 0.5% by weight, based on the thermoplastic polyurethane (P), preferably in the range from 0.03% by weight to 0.1% by weight, further preferably in the range from 0.04% by weight to 0.08% by weight, based in each case on the thermoplastic polyurethane (P) or the reaction mixture (R-P).

The inventive polyurethane-comprising hotmelt adhesives may have various uses, for example as sealant, coating, as adhesive, especially as hotmelt adhesive, as assembly adhesive for preliminary fixing of components, as bookbinding adhesive, as adhesive for the production of block bottom valve sacks, for production of composite films and laminates, or as edgebanding product.

The present invention therefore also further relates to the use of a composition as described above or of a composition obtained or obtainable by a process as described above as sealant, coating or adhesive. The compositions of the invention may likewise be used for production of foils, fibers, films, injection-molded products, formed films or for 3D printing.

In a further embodiment, the present invention also relates to the use of a composition as described above or of a composition obtained or obtainable by a process as described above as hotmelt adhesive, assembly adhesive for fixing of components, bookbinding adhesive, adhesive for production of composite films, laminates, sandwich components or as edgebanding product.

The composition can be applied by means of spraying or laminating. The compositions of the invention are suitable for bonding of a wide variety of different materials, for example of metal, textiles, wood, ceramic or plastics. The compositions of the invention can especially be used for bonding or fixing of shaped bodies in the automotive industry, or of consumer goods, sports articles or footwear, for example footwear soles.

In a further embodiment, the present invention also relates to the use of a composition as described above or of a composition obtained or obtainable by a process as described above, wherein the adhesive is especially used for bonding of foils, fibers, films, injection-molded products, formed films or for 3D printing, especially in the automotive industry or for consumer goods, sports articles or footwear, for example footwear soles.

Further embodiments of the present invention are apparent from the claims and the examples. It will be appreciated that the features of the subject matter/processes/uses according to the invention that are recited hereinabove and elucidated hereinbelow are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

Illustrative embodiments of the present invention are listed below, but do not restrict the present invention. In particular the present invention also encompasses those embodiments that result from the dependency references and hence combinations specified hereinbelow. More particularly, in the case of naming of a range of embodiments hereinafter, for example the expression “The process according to any of embodiments 1 to 4”, should be understood such that any combination of the embodiments within this range is explicitly disclosed to the person skilled in the art, meaning that the expression should be regarded as being synonymous to “The process according to any of embodiments 1, 2, 3 and 4”.
1. A composition comprising at least one crosslinkable thermoplastic polyurethane (P) and at least one compound (N) having a conjugated, nitrogen-containing aromatic structure as nucleating agent, wherein the compound (N) is a solid and is present in the composition in an amount within a range from 0.01% to 0.5% by weight, based on the thermoplastic polyurethane.
2. The composition according to embodiment 1, wherein the nucleating agent is selected from the group consisting of quinacridones, monoazo compounds, perylenes, diketopyrrolopyrroles, isoindolines and phthalocyanines or derivatives of these compounds.
3. The composition according to either of embodiments 1 and 2, wherein the nucleating agent is selected from the group consisting of quinacridones and perylenes or derivatives of these compounds.
4. The composition according to any of embodiments 1 to 3, wherein the amount of the sum total of the nucleating agents used is in the range from 0.03% by weight to 0.1% by weight, based on the thermoplastic polyurethane (P).
5. The composition according to any of embodiments 1 to 4, wherein a nucleating agent that has been subjected to a treatment comprising grinding, treatment with a solvent, acids, alkalis, bleaches, crystallization or extraction, and finishing operations to reduce or prevent flocculation or lump formation, finishing operations to control the particle size, or finishing operations to regulate the viscosity is used.
6. The composition according to any of embodiments 1 to 5, wherein the nucleating agent is used in solid form with a specific surface area in the range from 10 m²/g to 150 m²/g.
7. A process for producing a composition according to any of claims 1 to 6, at least comprising the steps of
   (i) providing at least one crosslinkable thermoplastic polyurethane (P) or a reaction mixture for preparation of a crosslinkable thermoplastic polyurethane (R-P);
   (ii) adding at least one compound (N) that has a conjugated, nitrogen-containing aromatic structure as nucleating agent to the at least one thermoplastic polyurethane (P) or to the reaction mixture for preparation of a crosslinkable thermoplastic polyurethane (R-P), where the compound (N) is a solid;
   (iii) mixing the nucleating agent and the thermoplastic polyurethane (P) or the reaction mixture (R-P),
   wherein the amount of the sum total of the nucleating agents used is in the range from 0.01% by weight to 0.5% by weight, based on the thermoplastic polyurethane (P) or the reaction mixture (R-P).
8. The process according to embodiment 7, wherein the nucleating agent is selected from the group consisting of quinacridones, monoazo compounds, perylenes, diketopyrrolopyrroles, isoindolines and phthalocyanines or derivatives of these compounds.
9. The process according to either of embodiments 7 and 8, wherein the nucleating agent is selected from the group consisting of quinacridones and perylenes or derivatives of these compounds.
10. The process according to any of embodiments 7 to 9, wherein the amount of the sum total of the nucleating agents used is in the range from 0.03% by weight to 0.1% by weight, based on the thermoplastic polyurethane (P).
11. The use of a composition according to any of embodiments 1 to 6 or of a composition obtained or obtainable by a process according to any of embodiments 7 to 10 as sealant, coating or adhesive.
12. The use according to embodiment 11, wherein the adhesive is used as hotmelt adhesive, assembly adhesive for fixing of components, bookbinding adhesive, adhesive for production of composite films, laminates, sandwich components, or as edgebanding product.
13. The use according to embodiment 11, wherein the adhesive is used for bonding of wood, textiles, metals, ceramic or plastics.
14. The use according to embodiment 11, wherein the adhesive is especially used for bonding of foils, fibers, films, injection-molded products, shaped films, or for 3D printing, especially in the automotive industry, of consumer goods, sports articles or footwear, for example footwear soles.

The examples which follow are intended to illustrate the invention but are in no way intended to restrict the subject matter of the present invention.

### EXAMPLES

1. Compounds Used/Composition of the Polyurethanes

TABLE 1
Composition

| Name | Concentration (% by wt.) |
|---|---|
| Isocyanate | 11.7 |
| Polyol-A | 20.1 |
| Polyol-B | 21.6 |
| Polyol-C | 24.9 |
| Polyol-D | 21.7 |

Isocyanate: mixture of diphenylmethane diisocyanate isomers (4,4′: 98.6% by weight; 2,4′: 1.4% by weight)
Polyol-A: polypropylene glycol having an average molecular weight of 1970 g/mol and a functionality of 1.9
Polyol-B: polypropylene glycol having an average molecular weight of 4000 g/mol and a functionality of 2.0
Polyol-C: polyester polyol based on adipic acid and hexane-1,6-diol and having an average molecular weight of 3500 g/mol, acid number of max. 2 mg
KOH/g, a functionality of 2.0 and a melting point peak maximum of 55° C. (measured via DSC).
Polyol-D: polyacrylate copolymer on methyl methacrylate and butyl methacrylate having an average molecular weight of 34 000 g/mol, and a glass transition of 76° C. (measured via DSC)
Solvenon DPM: dipropylene glycol monomethyl ether, CAS No. 34590-94-8, from BASF
Nucleating agent-A: Cinquasia K4535, 2,9-dichloroquinacridone, ground, acid extraction, C.I. Pigment Red 202, specific surface area 72.4 m²/g
Nucleating agent-B: Cinquasia K4410, solid solution of gamma-quinacridone and 2,9-dimethylquinacridone (ratio 1:3), C.I. Pigment Red 122, specific surface area 58.5 m²/g
Nucleating agent-C: Irgazin Yellow K2060, isoindoline, Pigment yellow 110, specific surface area 26.7 m²/g
Nucleating agent-D: Irgazin Yellow K2080, isoindoline, Pigment yellow 110, specific surface area 45.6 m2/g
Nucleating agent-E: Paliogen Red Violet K5411, perylene, Pigment violet 29, specific surface area 78 m²/g
Nucleating agent-F: Cromophtal Yellow L1061 HD, benzimidazolone (Pigment yellow 151), specific surface area 26.7 m²/g
Nucleating agent-G: Paliogen Blue L6470, indanthrone pigment, specific surface area 52 m²/g
Nucleating agent-H: Pigment Red 122
Reference-A: Finntalc MO5SL, talc with particle size features D98=9 microns, d50=2.2 microns and 44% particles below 2 microns
Reference-B: Irgaclear DM, bis(p-methylbenzylidene)sorbitol, CAS Number: 81541-12-0
Reference-C: Irgastab NA287, zinc glycerolate, CAS Number: 16754-68-0
Reference-D: ADK Stab NA71, 2,2′-methylenebis(2,4-di-tert-butylphenyl)phosphate lithium salt, CAS Number 85209-93-4
Reference-E: Millad NX8000, bis(4-propylbenzylidene)propylsorbitol, CAS Number 882073-43-0

2. Production of the PUR Hotmelt
Polyol-A, polyol-B, polyol-C and polyol-D were introduced into a reactor. The mixture was heated to 120° C. and a reduced pressure of 70 mbar was applied for a duration of 1.5 hours. Subsequently, the isocyanate was added and the mixture was stirred for a further 3 hours. Then Solvenon DPM was added to the reaction mixture. The molar ratio of Solvenon DPM to the remaining isocyanate groups was 1:1. The reaction was stopped and the material obtained was cooled. Inverse titration confirmed the absence of NCO groups.

3. Compounding of the PUR Hotmelt with Nucleating Agent
About 1 g of the PUR hotmelt obtained was admixed with the nucleating agent in a mortar. The concentration of the nucleating agent used is stated in table 2. Once the polyurethane had melted completely, the nucleating agent was dispersed homogeneously in the melt. When the mixture was visually homogeneous, it was cooled and stored.

4. DSC Analysis
About 10 mg of a polyurethane hotmelt and the mixture of polyurethane and nucleating agent were weighed into an aluminum boat. Under a nitrogen atmosphere, the sample was heated from room temperature to 120° C. After 3 minutes at 120° C., the sample was cooled to −80° C. Finally, the sample, after 3 minutes isothermal at −80° C., was heated back up to 120° C. The heating and cooling rate was 20 K/min. The crystallization peak in the cooling step was recorded.

TABLE 2
Concentration of the nucleating agent
and crystallization (peak) temperature

| ID | Nucleating agent | Concentration (% by wt.) | Tc (° C.) |
|---|---|---|---|
| 1 | — | 0 | 12 |
| 2 | Nucleating agent-A | 0.3 | 32 |
| 3 | Nucleating agent-B | 0.3 | 32 |
| 4 | Nucleating agent-C | 0.3 | 30 |
| 5 | Nucleating agent-D | 0.3 | 31 |
| 6 | Nucleating agent-E | 0.3 | 30 |
| 7 | Nucleating agent-F | 0.3 | 30 |
| 8 | Nucleating agent-G | 0.3 | 33 |
| 9 | Nucleating agent-H | 0.3 | 32 |
| 10 | Reference-A | 3 | 29 |
| 11 | Reference-B | 0.3 | 25 |
| 12 | Reference-C | 0.3 | 25 |
| 13 | Reference-D | 0.3 | 19 |
| 14 | Reference-E | 0.3 | 11 |

The measurements show that, when the nucleating agents of the invention are used, a change in the crystallization temperature of at least 5° C. is achieved. When reference-A is used, an increase in the concentration used by a factor of 10 is needed to achieve the same change in the crystallization temperature.

5. Measurement of Bond Strength with Use of the PUR Hotmelts
Tensile shear strength was measured using plywood samples. Roughly 1 mm-thick films of the PUR hotmelt or of the mixture of PUR hotmelt with the nucleating agent were sandwiched between two sheets with an overlap of about 10 mm. The sheets were pressed at 100° C. for 10 min (1 kg). Subsequently, the samples were removed and tested after different times. The results are shown in table 3. The maximum force was determined using a spring balance.

TABLE 3
Maximum force/time of bond strength

| ID | Nucleating agent | Time (min:sec) | Force (N) |
|---|---|---|---|
| 1 | — | 3:30 | 35 |
| 1 | — | 5:00 | 50 |
| 2 | Nucleating agent-A | 3:30 | 58 |
| 2 | Nucleating agent-A | 5:00 | 70 |
| 10 | Reference-A | 3:30 | 50 |
| 10 | Reference-A | 5:00 | 60 |

The measurements show that, when the inventive nucleating agent (I D2) is used, the adhesive achieves a higher bond strength than without nucleating agent or using a nucleating agent according to the prior art (I D10).

6. Efficacy of the Nucleating Agent in PUR Hotmelt
In order to show the efficacy of the nucleating agent in the PUR hotmelt formulations, the concentration of the nucleating agent H in the formulation was varied. The experiment was conducted according to the general description for the DSC analysis. The results are summarized in table 4. The concentration relates to the amount of the nucleating agent based on the PUR hotmelt.

TABLE 4
Crystallization peak as a function of the concentration
of the nucleating agent in the PUR hotmelt

| Concentration (% by wt.) | Tc (° C.) |
|---|---|
| 0.3 | 32 |
| 0.1 | 31 |
| 0.06 | 31 |
| 0.03 | 29 |

7. Production of a Reactive PUR Hotmelt
Polyol-A, polyol-B, polyol-C and polyol-D and the nucleating agent were introduced into a reactor. The mixture was heated to 120° C. and a reduced pressure of 70 mbar was applied for a duration of 1.5 hours. Subsequently, the isocyanate was added and the mixture was stirred for a further 3 hours. The composition of the mixture is shown in table 5. The reaction was stopped and the material obtained was cooled. No agglomeration was observed during the storage. The NCO content was determined by inverse titration.

TABLE 5
Composition of the reactive PUR hotmelts

| | RHM-ID 1 | RHM-ID2 | RHM-Ref1 |
|---|---|---|---|
| | Concentration | Concentration | Concentration |
| Name | (% by wt.) | (% by wt.) | (% by wt.) |
| Isocyanate | 11.7 | 11.7 | 11.7 |
| Polyol-A | 20.1 | 20.1 | 20.1 |
| Polyol-B | 21.6 | 21.6 | 21.6 |
| Polyol-C | 24.9 | 24.9 | 24.9 |
| Polyol-D | 21.7 | 21.7 | 21.7 |
| Nucleating | | 0.3 | |
| agent-A | | | |
| Reference-A | | | 3.0 |
| NCO content | 1.9 | 1.9 | 1.9 |
| (% by wt.) | | | |

8. Measurement of Initial Adhesion of Reactive PUR Hotmelts
Tensile shear strength was measured using plywood samples. Roughly 1 mm-thick films of the PUR hotmelt or of the mixture of reactive PUR hotmelt with the nucleating agent were sandwiched between two sheets with an overlap of about 10 mm. The sheets were pressed at 100′C for 10 min (1 kg). Subsequently, the samples were removed and, after 15 minutes, tested with a Zwick/Roell testing machine at 25 mm/min and initial load 1 N. 3 samples were tested for each system. The sample without nucleating agent (RHM-ID-1) showed an average maximum force of 55 N, while samples with nucleating agent (RHM-1D2 and RHM-Ref1) showed an average maximum force of about 90 N. RHM-ID2 showed similar characteristics to sample RHM-Ref1 with just 1/10 of the concentration of the nucleating agent.

### LITERATURE CITED

EP 0 199 021 A2
DE 38 27 224 A1
WO2005/066256
WO 2008/155018 A1
“Lehrbuch der Lacke und Beschichtungen” by Hans Kittel, volume 5 (5. Pigmente, Füllstoffe und Farbmetrik/volume ed. Jürgen Spille), chapter 5.4, 2003, ISBN 3-7776-1015-1
“Kunststoffhandbuch, volume 7, Polyurethane”, Carl Hanser Verlag, 3rd edition, 1993, chapter 3.1

1. A composition, comprising:
at least one crosslinkable thermoplastic polyurethane (P) and
at least one compound (N) comprising a conjugated, nitrogen-containing aromatic structure as a nucleating agent,
wherein the at least one compound (N) is a solid and is present in the composition in an amount of from 0.01% by weight to 0.5% by weight, based on the at least one crosslinkable thermoplastic polyurethane (P).

2. The composition of claim 1, wherein the nucleating agent is selected from the group consisting of a quinacridone, a monoazo compound, a perylene, a diketopyrrolopyrrole, an isoindoline, a phthalocyanine and derivatives thereof.

3. The composition of claim 1, wherein the nucleating agent is selected from the group consisting of a quinacridone, a perylene and derivatives thereof.

4. The composition of claim 1, wherein a total amount of nucleating agents is in a range of from 0.03% by weight to 0.1% by weight, based on the at least one crosslinkable thermoplastic polyurethane (P).

5. The composition of claim 1, comprising a nucleating agent that has been subjected to a treatment comprising grinding, treatment with a solvent, acids, alkalis, bleaches, crystallization or extraction, and finishing operations to reduce or prevent flocculation or lump formation, finishing operations to control a particle size, or finishing operations to regulate a viscosity.

6. The composition of claim 1, wherein the nucleating agent is a solid with a specific surface area in a range of from 10 m²/g to 150 m²/g.

7. A process for producing the composition of claim 1, the process comprising:
(i) providing at least one crosslinkable thermoplastic polyurethane (P) or a reaction mixture for preparation of a crosslinkable thermoplastic polyurethane (R-P);
(ii) adding at least one compound (N) that comprises a conjugated,
nitrogen-containing aromatic structure as a nucleating agent to the at least one crosslinkable thermoplastic polyurethane (P) or to the reaction mixture for preparation of the crosslinkable thermoplastic polyurethane (R-P), where the at least one compound (N) is a solid; and
(iii) mixing the nucleating agent and the at least one crosslinkable thermoplastic polyurethane (P) or the reaction mixture for preparation of the crosslinkable thermoplastic polyurethane (R-P),
wherein a total amount of nucleating agents is in a range of from 0.01% by weight to 0.5% by weight, based on the at least one crosslinkable thermoplastic polyurethane (P) or the reaction mixture for preparation of the crosslinkable thermoplastic polyurethane (R-P).

8. The process of claim 7, wherein the nucleating agent is selected from the group consisting of a quinacridone, a monoazo compound, a perylene, a diketopyrrolopyrrole, an isoindoline, a phthalocyanine and derivatives thereof.

9. The process of claim 7, wherein the nucleating agent is selected from the group consisting of a quinacridone, a perylene and derivatives thereof.

10. The process of claim 7, wherein the total amount of nucleating agents is in a range of from 0.03% by weight to 0.1% by weight, based on the at least one crosslinkable thermoplastic polyurethane (P).

11. A sealant, coating or adhesive, comprising the composition of claim 1.

12. The sealant, coating or adhesive of claim 11, which is an adhesive, wherein the adhesive is a hotmelt adhesive, an assembly adhesive for fixing of a component, a bookbinding adhesive, an adhesive for production of a composite film, a laminate, a sandwich component, or an edgebanding product.

13. A method of bonding wood, textiles, metals, ceramic or plastics, the method comprising contacting wood, a textile, a metal, ceramic or a plastic with the sealant, coating or adhesive of claim 11.

14. A method of bonding foils, fibers, films, injection-molded products, or shaped films, or of 3D printing, the method comprising contacting a foil, a fiber, a film, an injection-molded product, or a shaped film with the sealant, coating or adhesive of claim 11, or comprising 3D printing the sealant, coating or adhesive.

15. A sealant, coating or adhesive, comprising a composition obtained or obtainable by the process of claim 7.

16. The sealant, coating or adhesive of claim 15, which is a hotmelt adhesive, an assembly adhesive for fixing of a component, a bookbinding adhesive, an adhesive for production of a composite film, a laminate, a sandwich component, or an edgebanding product.

17. A method of bonding wood, textiles, metals, ceramic or plastics, the method comprising contacting wood, a textile, a metal, ceramic or a plastic with the sealant, coating or adhesive of claim 15.

18. A method of bonding foils, fibers, films, injection-molded products, or shaped films, or of 3D printing, the method comprising contacting a foil, a fiber, a film, an injection-molded product, or a shaped film with the sealant, coating or adhesive of claim 15, or the method comprising 3D printing the sealant, coating or adhesive.
